(19) United States
(12) Patent Application Publication
(10) Pub. No.: US 2014/0306035 A1
(43) Pub. Date: Oct. 16, 2014

(54) ELECTRODE ASSEMBLY AND ELECTROSTATIC ATOMIZER HAVING SUCH AN ELECTRODE ASSEMBLY

(71) Applicant: EISENMANN AG, Böblingen (DE)

(72) Inventors: Jörg Pfau, Boblingen (DE); Jan Reichler, Konstanz (DE)

(21) Appl. No.: 14/363,926

(22) PCT Filed: Dec. 12, 2012
(86) PCT No.: PCT/EP2012/005116

§ 371 Date: Jun. 9, 2014

(30) Foreign Application Priority Data
Dec. 22, 2011 (DE) 10 2011 121 915.7

(51) Int. Cl. B05B 5/053; B05B 5/04

(52) U.S. Cl. CPC B05B 5/0533; B05B 5/04
USPC 239/690; 315/59

(57) ABSTRACT

The invention relates to an electrode assembly for an electrostatic atomizer, in particular for an electrostatic rotary atomizer, comprising at least one outer electrode and an electric resistance device, which has at least one resistance unit that is connected via an electrode connection to the at least one outer electrode and can be connected via a contact connection to a pole of a high-voltage source. The electrode assembly defines a main axis around which an electric field is built up. The resistance unit comprises a resistance track that runs between the electrode connection and the contact connection and is carried by a carrier substrate. The invention also relates to an electrostatic atomizer having such an electrode assembly.

The invention relates to an electrode assembly for an electrostatic atomizer, in particular for an electrostatic rotary atomizer, having
a) at least one external electrode;
b) an electrical resistance device comprising at least one resistance unit which is connected via an electrode terminal to the at least one external electrode and can be connected via a contact terminal to a pole of a high-voltage source;

wherein
c) the electrode assembly defines a main axis about which an electric field is built up.

The invention relates additionally to an electrostatic atomizer, in particular an electrostatic rotary atomizer.

Electrostatic atomizers are used, for example, in the automotive industry for coating objects such as motor vehicle bodies or body parts. The coating material, for example a paint, is thereby delivered by a delivery device and exposed to an electric field, in which the delivered coating material is ionised and transported on the basis of electrostatic forces to the object, which for this purpose is at earth potential, for example. In a rotary atomizer, the delivery device is in the form of a rotating bell disc, from which very small droplets of paint are thrown off, so that a paint mist forms.

In such atomizers, ionisation of the paint or paint particles can take place by so-called internal charging. In internal charging, the paint inside the rotary atomizer passes a high-voltage internal electrode on its path to the bell disc, whereby it picks up electric charges.

In electrostatic atomizers having an electrode assembly of the type mentioned at the beginning, which comprises at least one external electrode, ionisation of the paint or paint particles takes place by so-called external charging. A plurality of external electrodes is generally arranged around the bell disc, by means of which electrodes the air located therebetween is ionised. The initially neutral paint particles are charged as they pass through the ionised air and thus are likewise ionised. A rotary atomizer with external charging is known, for example, from DE 196 11 369 A1 or DE 34 29 075 A1.

The resistance device serves as a damping resistance and suppresses rapid current changes. As a result it is possible, for example, to prevent undesirable arcing from the external electrodes to the object that is to be coated if the high-speed rotary atomizer is unintentionally brought too close to an earthed object. The resistance per external electrode is conventionally between 100 mega-ohms and 150 mega-ohms at a high-voltage potential of approximately 50 kV.

In such rotary atomizers with external charging, the external electrodes are, however, quite long and project comparatively far forwards in the direction of the main axis, which generally coincides with the axis of rotation of the bell disc. Use of the rotary atomizer in locations that are relatively confined in terms of space is accordingly frequently possible to only a limited extent.

The object of the invention is, therefore, to provide an electrode assembly and an atomizer of the type mentioned at the beginning which can be in a more compact form.

The object is achieved in the case of an electrode assembly of the type mentioned at the beginning in that
d) the resistance unit comprises a resistance track which runs between the electrode terminal and the contact terminal and which is carried by a carrier substrate.

The invention is based on the finding that, by modifying the resistance device, the external electrodes can be made shorter, so that the electrode assembly, and accordingly also an atomizer equipped therewith, can be made more compact in particular in the direction of the main axis.

In known high-speed rotary atomizers with external charging, the resistances are incorporated into the external electrodes. Two resistances are frequently connected in series in each external electrode. A conventional 50 mega-ohm resistance has, for example, a diameter of 8 mm and a length of approximately 60 mm.

Two such resistances in an external electrode thus increase its length by 120 mm.

By providing such a resistance in the form of a resistance track it is possible, for example, to save a particularly large amount of installation space if the resistance track runs perpendicularly to the main axis.

It is particularly advantageous if the resistance track is printed onto the carrier substrate.

In order to achieve good insulation and avoid high-voltage arcing via the resistance device, it is advantageous if the carrier substrate is made of a ceramics material or a plastics material.

It is particularly advantageous if the resistance unit is so arranged between the carrier substrate and a counter-substrate that a laminate structure is formed.

In addition, it is advantageous in this context if the carrier substrate together with the resistance unit is enclosed by an electrically non-conductive sleeve.

It is even better if the laminate structure as a whole is enclosed by an electrically non-conductive sleeve.

Advantageously, the sleeve is formed of an electrically non-conductive plastics material, in particular a resin material.

Particularly effective ionisation of coating material is achieved if a plurality of external electrodes is present.

In this case it is advantageous if a plurality of resistance units is also present.

If each external electrode is electrically connected to an electrode terminal of an individual resistance unit, an individual damping resistance can be associated with each external electrode.

A common terminal lead can be provided, via which the contact terminals of all the resistance units can be connected to a high-voltage source.

Alternatively, the contact terminals of individual resistance units can each be connectable separately to a high-voltage source, or the contact terminals of at least two resistance units can be connectable to a high-voltage source via a common terminal lead. In this manner, high voltage can be applied differently to individual external electrodes or groups thereof.

The electrode assembly is particularly compact if the carrier substrate is in sheet form and is arranged at an angle other than 0° to the main axis.

Preferably, the angle is 90°. This means that the resistance track extends in a plane that is perpendicular to the main axis. The main extent of the resistance unit is accordingly in a direction perpendicular to the main axis.

The above-mentioned object is achieved in the case of an electrostatic atomizer of the type mentioned at the beginning in that it comprises an electrode assembly having some or all of the features discussed above, as is apparent from the claims.

Exemplary embodiments of the invention will be explained in greater detail below with reference to the drawings, in which:

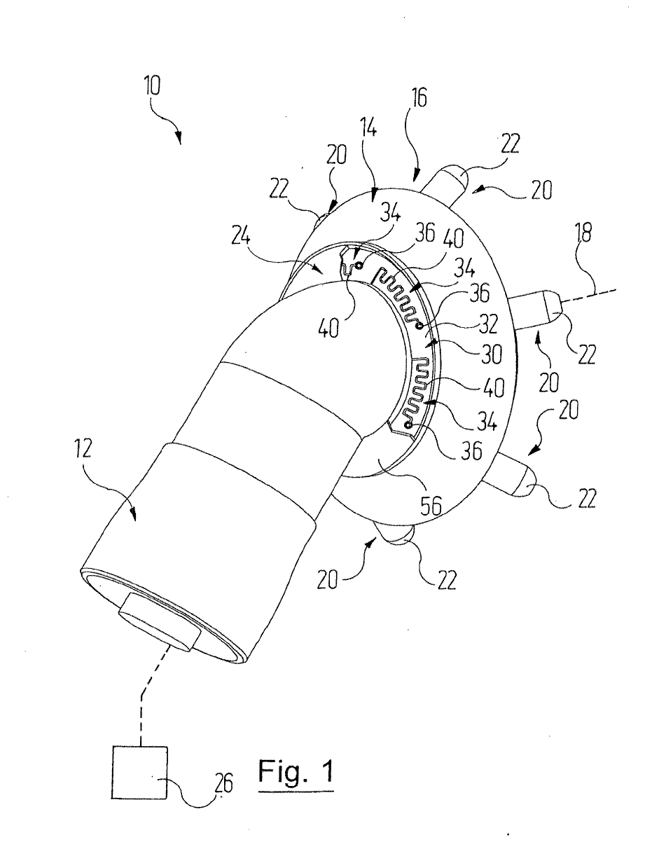

FIG. 1 shows a perspective view of a high-speed rotary atomizer having an electrode assembly, wherein the housing of a resistance device is shown partly broken away;

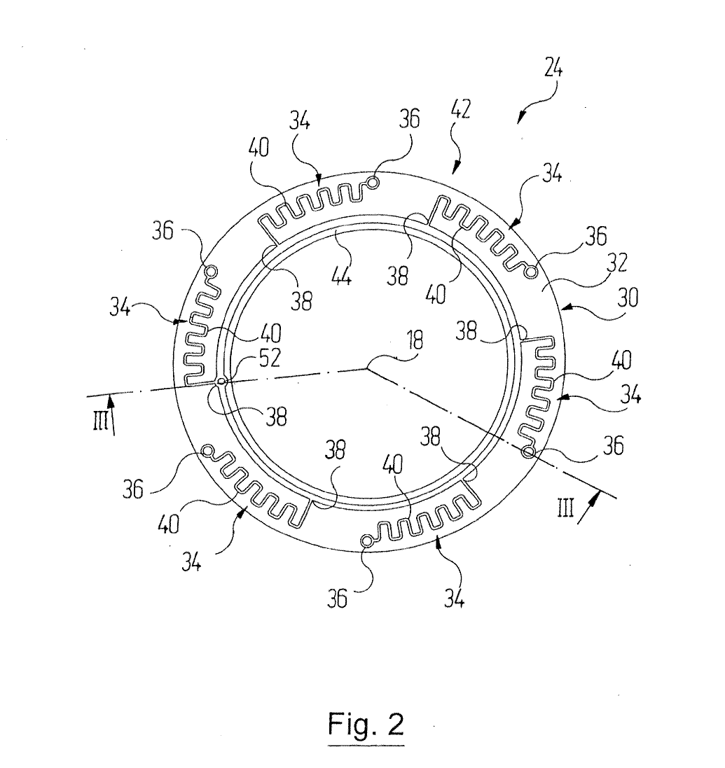

FIG. 2 shows a view of a resistance assembly according to a first exemplary embodiment of a resistance device of a first construction;

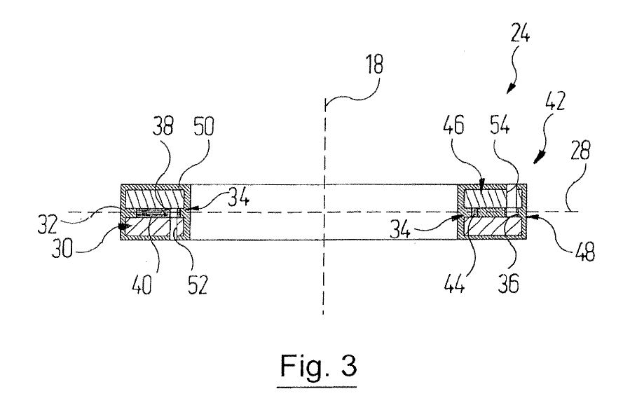

FIG. 3 shows a section of the resistance device with the resistance assembly according to FIG. 2 along the angled cutting line III-III shown therein;

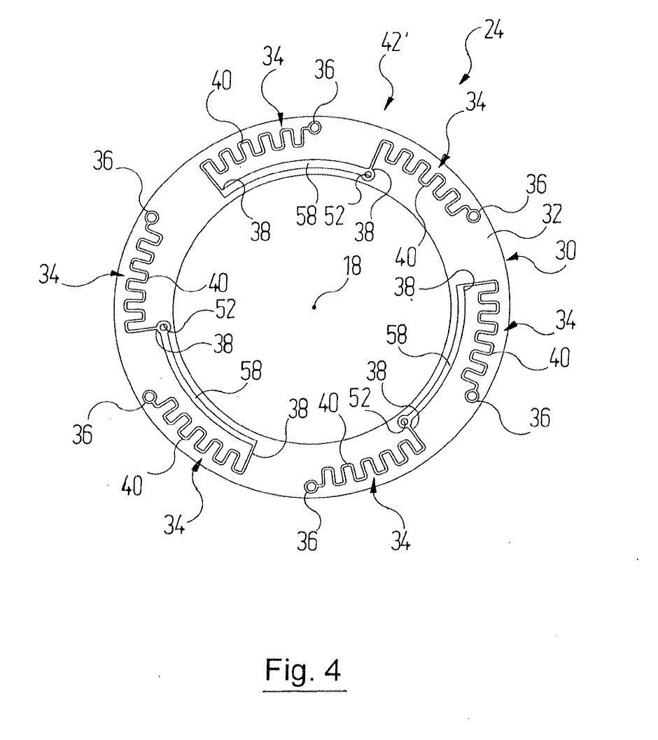

FIG. 4 shows a view corresponding to FIG. 2 of a resistance assembly according to a second exemplary embodiment;

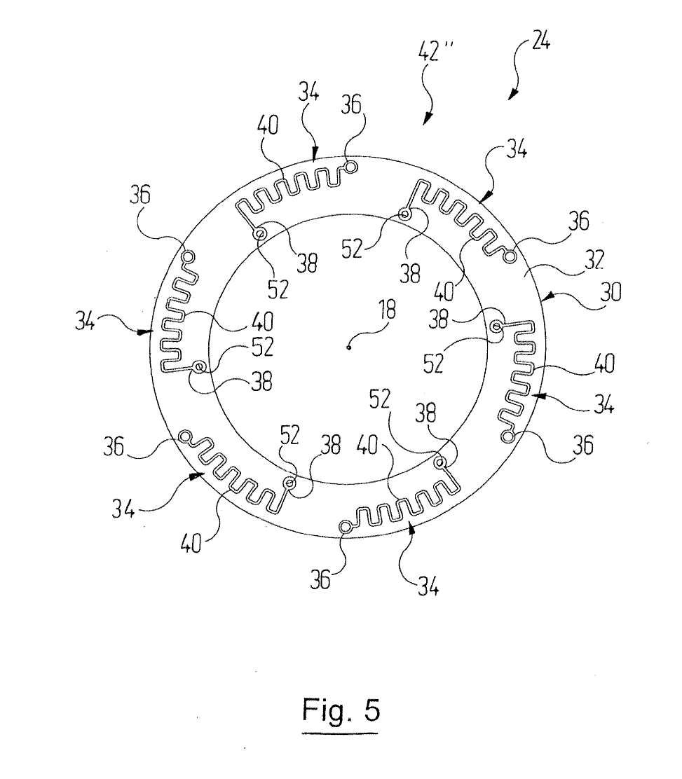

FIG. 5 shows a view corresponding to FIGS. 2 and 4 of a resistance assembly according to a third exemplary embodiment;

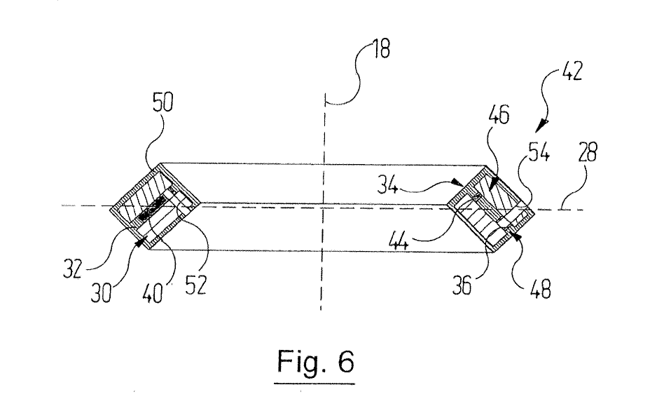

FIG. 6 shows a section corresponding to FIG. 3 of a modified resistance device of a second construction.

In FIG. 1, 10 designates generally an electrostatically operating high-speed rotary atomizer which can be coupled by way of a coupling section 12 to the arm of a multi-axis application robot (not shown), as is known per se.

By means of the high-speed rotary atomizer 10, paint can be applied to an object (not shown). To that end, the high-speed rotary atomizer 10 comprises a head section 14 in which there is incorporated in a manner known per se a bell disc which rotates at high speed during application of the paint and via which a paint mist is delivered. The bell disc cannot itself be seen in FIG. 1.

The high-speed rotary atomizer 10 operates according to the so-called external charging principle and comprises to that end an electrode assembly 16 which defines a main axis 18 which in the present exemplary embodiment coincides with the axis of rotation of the bell disc. An electric field is built up around the main axis 18.

The electrode assembly 16 comprises a plurality of external electrodes 20. In the present exemplary embodiment they are in the form of bar electrodes 22, six such bar electrodes 22 being arranged symmetrically to the main axis 18 around the bell disc.

The bar electrodes 22 are connected via an electrical resistance device 24 to a pole of a high-voltage source 26, which in FIG. 1 is shown only schematically. The other pole of the high-voltage source 26 is connected to an object that is to be coated, which must be electrically conductive and is thus at earth potential.

The bar electrodes 22 operate as spray electrodes and ionise the paint particles delivered by the bell disc of the high-speed rotary atomizer 10, which then migrate, owing to the electric field that is present, to the object, which is thereby coated. To that end, the bar electrodes 22 have needle-shaped tips, as is known per se.

As explained at the beginning, the resistance device 24 serves as a damping resistance and prevents rapid current changes. The resistance device 24 is here particularly flat in construction and is so arranged that the axial extent of the bar electrodes 22, and accordingly the axial extent of the head section 14 of the high-speed rotary atomizer 10, in the direction of the main axis 18 is kept small.

The resistance device 24 has its main extent in a main extent plane 28, which is shown in each of FIGS. 3 and 6 and is at an angle on the main axis 18 of the electrode assembly 16. In the present exemplary embodiment, that angle is 90°.

In order to achieve the desired flat construction of the resistance device 24, it comprises, for example in a first construction, a flat annular carrier substrate 30 which has a correspondingly annular carrying surface 32 and which carries six resistance units 34, so that each bar electrode 22 is able to cooperate with a resistance unit 34.

Each resistance unit 34 comprises an electrode terminal 36, with which the resistance unit 34 is connected to a bar electrode 22, and a contact terminal 38, via which the resistance unit 34 can be connected to the high-voltage source 26.

A resistance track 40 runs between the electrode terminal 36 and the contact terminal 38. In the present exemplary embodiment, the resistance track 40 is printed onto the carrier substrate 30 and has a meandering path. The size of the resistance depends on the length of the resistance track 40, so that the size of the resistance can be set by means of a correspondingly wound path, the region of the carrying surface 32 of the carrier substrate 30 required for the resistance unit 34 not changing. The concrete path of a resistance track 40 can consequently vary and can also differ between two resistance units 34 of the same resistance device 24.

In practice, it has been found to be successful if the carrier substrate 30 is made of a ceramics material or a plastics material.

The resistance units 34 are connected to form a resistance assembly 42. To that end, a common terminal lead 44 is provided, which connects together the contact terminals 38 of all the resistance units 34, so that the contact terminals of all the resistance units can be connected via the terminal lead 44 to the high-voltage source 26.

As can be seen in FIG. 3, there is located on the side of the resistance units 34 remote from the carrier substrate 30 a counter-substrate 46, which is adapted to the carrier substrate 30 in terms of its shape and size and is here accordingly likewise in the form of a flat ring. The resistance units 34 are so arranged between the carrier substrate 30 and the counter-substrate 46 that a laminate structure 48 is formed.

The laminate structure 48 is enclosed by an electrically non-conductive sleeve 50, which can be formed, for example, of an electrically non-conductive plastics material such as, for example, a resin material. In a modification, it is also possible to omit the counter-substrate 46, the carrier substrate 30 with the resistance units 34 then being enclosed by the electrically non-conductive sleeve 50. The counter-substrate 46 and the sleeve 50 are not shown in FIGS. 1, 2, 4 and 5 for the sake of clarity.

The resistance device 24 comprises a contact terminal channel 52 which passes from the outside through the sleeve 50 and the carrier substrate 30 to the terminal lead 44, so that the terminal lead 44 is accessible from the outside and can be connected to the high-voltage source 26.

In a corresponding manner, the resistance device 24 comprises an electrode terminal channel 54 for each electrode terminal 36 of the resistance units 34, one of which electrode terminal channels 54 can be seen in FIG. 3. The electrode terminal channels 54 each pass from the outside through the sleeve 50 and the counter-substrate 46 to an associated electrode terminal 36 of a resistance unit 34.

The resistance device 24 is accommodated in an annular housing 56 and is arranged on the side of the head section 14 of the high-speed rotary atomizer 10 that is remote from the bar electrodes 22 and encloses the components thereof that are s present on the inside.

In FIG. 4, a modified resistance assembly 42′ is shown as a second exemplary embodiment. Two contact terminals 38 of two adjacent resistance units 34 are there connected to one another via a common terminal lead 58, so that two resistance units can be connected as a group to the high-voltage source 26. The bar electrodes 22 can thus always be supplied with high voltage as a pair. In the resistance device 24 so formed there are accordingly three contact terminal channels via which the terminal leads 58 are accessible from the outside but which are not visible in FIG. 4.

In FIG. 5, a further modified resistance assembly 42″ is shown as a third exemplary embodiment. The contact terminals 38 of the resistance units 34 can there each be connected separately to the high-voltage source 26. To that end, six contact terminal channels are accordingly present in the resistance device 24 so formed, via which contact terminal channels the contact terminals 38 are directly accessible from the outside but which are not visible in FIG. 5. Each bar electrode 22 can thus be supplied separately with high voltage.

FIG. 6 shows a resistance device 24 of a second construction. The carrier substrate 30 and the counter-substrate 46 are there in the form not of flat rings but of frustoconical rings which are arranged coaxially with respect to one another and receive between them the resistance units 34.

The resistance device 24 according to FIG. 6 illustrates that other configurations using resistance tracks 40 are also suitable for keeping the extent of the external electrodes 20 in the direction of the main axis 18 smaller than was hitherto possible.

The resistance device 42 can also be designed as an interchangeable module. In this case, a set with a plurality of resistance devices 42 is provided, the resistance units 34 of which offer different resistances, the size of which is dependent on the length of the resistance track 40 in question.

In a modification that is not shown, the resistance device 24 is adjustable so that its effective resistance, or the effective resistance of individual resistance units 34, can be changed. To that end, for example, the resistance track 40 of a resistance unit 34 can be connected to the electrode terminal 36 in different places, so that the effective length of the resistance track 40 between the contact terminal 38 and the electrode terminal 36 can be adjusted.

1. An electrode assembly for an electrostatic atomizer, in particular for an electrostatic rotary atomizer, comprising:
a) at least one external electrode;
b) an electrical resistance device comprising at least one resistance unit which is connected via an electrode terminal to the at least one external electrode and can be connected via a contact terminal to a pole of a high-voltage source;
wherein
c) the electrode assembly defines a main axis about which an electric field is built up,
wherein
the resistance unit comprises a resistance track which runs between the electrode terminal and the contact terminal and is carried by a carrier substrate.

2. The electrode assembly according to claim 1, wherein the resistance track is printed onto the carrier substrate.

3. The electrode assembly according to claim 1, characterised in that wherein the carrier substrate is made of a ceramics material or a plastics material.

4. The electrode assembly according to claim 1, wherein the resistance unit is so arranged between the carrier substrate and a counter-substrate that a laminate structure is formed.

5. The electrode assembly according to claim 1, wherein the carrier substrate together with the resistance unit is enclosed by an electrically non-conductive sleeve.

6. The electrode assembly according to claim 4, wherein the laminate structure is enclosed by an electrically non-conductive sleeve.

7. The electrode assembly according to claim 5, wherein the sleeve is formed of an electrically non-conductive plastics material, in particular a resin material.

8. The electrode assembly according to claim 1, wherein a plurality of external electrodes is present.

9. The electrode assembly according to claim 8, characterised in wherein a plurality of resistance units is present.

10. The electrode assembly according to claim 9, wherein each external electrode is electrically connected to an electrode terminal of an individual resistance unit.

11. The electrode assembly according to claim 9, wherein a common terminal lead is present, via which the contact terminals of all the resistance units can be connected to a high-voltage source.

12. The electrode assembly according to claim 9, wherein the contact terminals of individual resistance units can each be connected separately to a high-voltage source, or the contact terminals of at least two resistance units can be connected via a common terminal lead to a high-voltage source.

13. The electrode assembly according to claim 1, wherein the carrier substrate is in sheet form and is arranged at an angle other than 0° to the main axis.

14. The electrode assembly according to claim 13, wherein the angle is 90°.

15. The electrostatic atomizer, in particular electrostatic rotary atomizer, having an electrode assembly according to claim 1.
